(19) United States
(12) Patent Application Publication
(10) Pub. No.: US 2008/0136934 A1
(43) Pub. Date: Jun. 12, 2008

(54) Flame Detecting Method And Device

(75) Inventors: Hao-Ting Zhao, Hsinchu (TW); Chung-Hsien Lu, Taipei (TW); Yu-Ren Hsu, Hsinchu (TW); Shen-Kuen Chang, Hsinchu (TW); Yi Chih Chen, Hsinchu (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Industrial Technology Research Institute, Hsinchu (TW)

(21) Appl. No.: 11/760,661

(22) Filed: Jun. 8, 2007

(30) Foreign Application Priority Data
Dec. 12, 2006 (TW) 095146545

(51) Int. Cl. H04N 5/228; G06K 9/00

(52) U.S. Cl. 348/226.1; 382/107; 348/E05.031

(57) ABSTRACT

A flame detecting method is provided. The method comprises steps of capturing a video segment for a object; analyzing if an image of the object is moving; analyzing at least one of a color model and a flickering frequency of the moving object; comparing analyzed results obtained from the analyzing steps to a flame feature; and determining if the object is a flame.

### FIELD OF THE INVENTION

The present invention relates to a flame detecting method and device, and more particular to a flame detecting method and device using the image analyzing.

### BACKGROUND OF THE INVENTION

Since the scales of the offices and factories are bigger and bigger, the altitude thereof is higher and higher, the structures thereof are more and more peculiar and the facilities thereof are more and more complicated, the common fire fighting facilities are not able to ensure the safety thereof. If the conventional monitoring system can be modified to catch and analyze images and determine if there is flame therein through the calculation of algorithm, the calamities might be detected and controlled efficiently and immediately.

The image determining method is to recognize the flame through various steps of algorithm. The first step is to capture the images through the monitoring system. Then the motilities and the color models of the objects in the images are analyzed by the calculating processors, such as the computers and the digital signal processor (DSP). The conventional recognizing methods such as the background subtraction method, the statistical method, the temporal differencing method and the optical flow method are to separate the pixels whose pixel property difference exceeds a threshold value in the images and compare these pixels to a flame color model. If the conditions of the objects in the images meet the flame features, the objects might be identified as flame. These conventional recognizing methods use the RGB color model as a comparing basis. However, the color recognition accuracy of the RGB color model is not good enough. Therefore, the objects with similar color to the flame are identified as having the flame properties.

Moreover, the conventional recognizing methods only use the motion detecting and the color model recognizing, which easily results in the misrecognizing and thus the incorrect identification. For example, if a man dressed in red walks through the monitor, he will be identified as a moving object with red element of flame red and determined as the flame, thereby triggering a fake alarm.

In order to overcome the drawbacks in the prior art, an improved flame detecting method and device are provided. The particular design in the present invention not only solves the problems described above, but also is easy to be implemented. Thus, the present invention has the utility for the industry.

### SUMMARY OF THE INVENTION

The major aspect of the present invention is to provide a flame detecting method and device to monitor and determine if a flame is happening for alarming or putting out the flame in time.

According to the major aspect of the present invention, a flame detecting method is provided. The flame detecting method includes the steps of capturing a video segment for a object; analyzing if an image of the object is moving; analyzing at least one of a color model and a flickering frequency of the image; comparing analyzed results obtained from the analyzing steps to a flame feature; and determining if the object is a flame.

Preferably, the flame detecting method further comprises a step of sending out an alarm when the object is determined as the flame.

According to the major aspect of the present invention, a flame detecting device is provided. The flame detecting device includes an image capturing device capturing a video segment having an image for a object; a first analyzing device coupled to the image capturing device and analyzing if the object is moving; a second analyzing device coupled to the image capturing device and analyzing at least one of a color model and a flickering frequency of the image; and a comparing device coupled to the analyzing devices and comparing analyzed results obtained from the analyzing devices to a flame feature.

Preferably, the flame detecting device further comprises a storage device coupled to the comparing device and storing the flame feature.

Preferably, the storage device further stores the analyzed results when the object is the flame for updating the flame feature.

Preferably, the flame detecting device further comprises an alarming device coupled to the comparing device for generating an alarm when the object is the flame.

Preferably, the image capturing device is one of a web camera and a cable camera.

Preferably, the color model is a Gaussian mixture model resulting from a statistics for a color of the object.

According to the major aspect of the present invention, a flame detecting device is provided. The flame detecting device includes an image capturing device capturing an image of an object; and a first analyzing device coupled to the image capturing device for analyzing at least one of a flickering frequency and a color model of the image for determining if the substrate is a flame.

Preferably, the flame detecting device further comprises a second analyzing device coupled to the image capturing device and analyzing if the object is moving; and a comparing device coupled to the analyzing devices and comparing analyzed results obtained from the analyzing devices to the flame feature.

Preferably, the flame detecting device further comprises a storage device coupled to the comparing device and storing the flame feature.

Preferably, the storage device further stores the analyzed results when the object is the flame for updating the flame feature.

Preferably, the flame detecting device further comprises an alarming device coupled to the flame detecting device for generating an alarm when the object is the flame.

Preferably, the image capturing device is one of a web camera and a cable camera.

Preferably, the flickering frequency is a color variation of the image varying with time.

Preferably, the color model is a Gaussian mixture model resulting from a statistics for a color of the object.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1A illustrates the structure of the flame detecting device according to a first preferred embodiment of the present invention;

FIG. 1B illustrates the structure of the flame detecting device according to a second preferred embodiment of the present invention;

FIG. 1C illustrates the structure of the flame detecting device according to a third preferred embodiment of the present invention; and

FIG. 2 illustrates the flow chart of the flame detecting method in the present invention.

### DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

For overcoming the problem of the fake alarm or the delay of putting out the flame caused by the incorrect identification of the conventional detecting method, a flame detecting method and device are provided. The flame detecting device in the present invention comprises a database storing the flame features including the Gaussian color model and the flickering frequency for comparing to the analyzed results and precisely recognizing and determining the flame features.

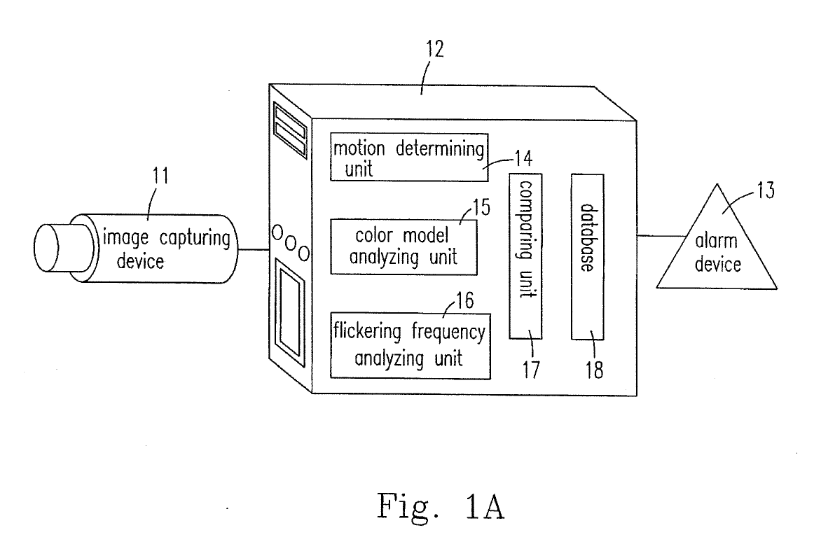

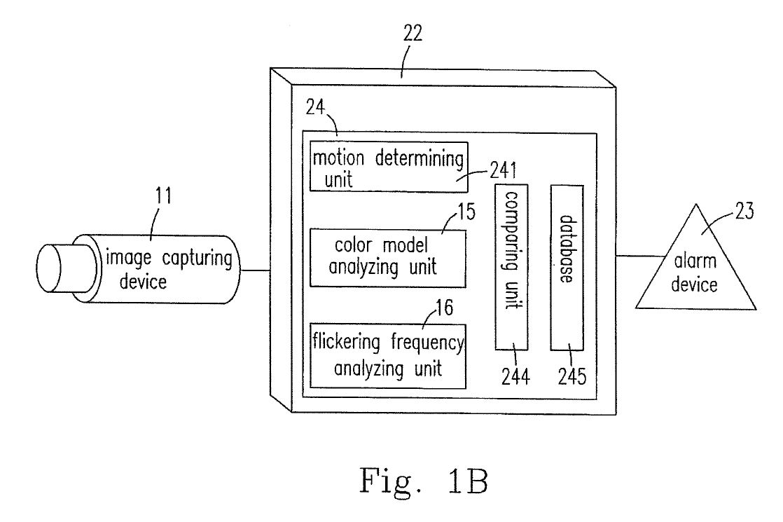

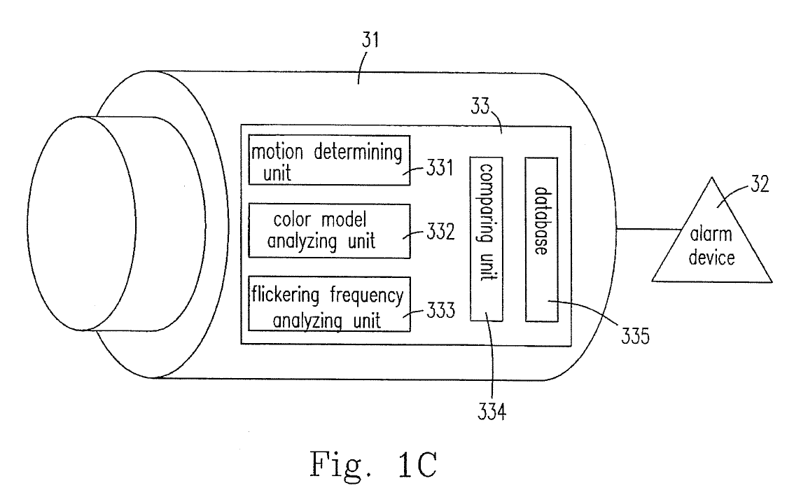

Please refer to FIG. 1A, which illustrates the structure of the flame detecting device according to a first preferred embodiment of the present invention. The flame detecting device includes an image capturing device 11, a computer 12 and an alarm device 13, in which the computer 12 has a motion determining unit 14, a color model analyzing unit 15, a flickering frequency analyzing unit 16, a comparing unit 17 and a database 18. The database 18 stores abundant flame features obtained from experiments including the Gaussian color model and the flickering frequency data.

The flame detecting device captures a video segment containing several objects through the image capturing device 11. Whether the objects are moving are determined by using the updating background motion determining method of the motion determining unit 14. The colors of the moving objects are analyzed by the color model analyzing unit 15. The flickering frequency relates to the color variation of the moving objects with time which is analyzed by using the time wavelet calculating method of the flickering frequency analyzing unit 16. Then, the comparing unit 17 compares the analyzed data to the fire features data in the database 18 to determine if the objects have the same color model and flickering frequency as the flame. If the above features of the objects match the flame features, the computer 12 determines the objects as flames and generates an alarm signal through the alarm device 13. The alarm device 13 sends the alarm signal to the central controlling computer of the fire monitoring center, the flame signal receiver or a cellphone.

Please refer to FIG. 1B, which illustrates the structure of the flame detecting device according to a second preferred embodiment of the present invention. The flame detecting device includes an image capturing device 21, a digital video recorder 22 and an alarm device 23. The digital video recorder 22 comprises a digital signal processor 24, which contains a motion determining unit 241, a color model analyzing unit 242, a flickering frequency analyzing unit 243, a comparing unit 244 and a database 245. The database 245 stores abundant flame features obtained from experiments including the Gaussian color model and the flickering frequency data.

The flame detecting device captures a video segment containing several objects through the image capturing device 21. Whether the objects are moving are determined by using the updating background motion determining method of the motion determining unit 241. The colors of the moving objects are analyzed by the color model analyzing unit 242. The flickering frequency relates to the color variation of the moving objects with time which is analyzed by using the time wavelet calculating method of the flickering frequency analyzing unit 243. Then, the comparing unit 245 compares the analyzed data to the flame features data in the database 246 to determine if the objects have the same color model and flickering frequency as the flame. If the above features of the objects match the flame features, the flame detecting device determines the objects as flames and generates an alarm signal through the alarm device 23. The alarm device 23 sends the alarm signal to the central controlling computer of the fire monitoring center, the flame signal receiver or a cellphone.

Please refer to FIG. 1C, which illustrates the structure of the flame detecting device according to a third preferred embodiment of the present invention. The flame detecting device includes an image capturing device 31 and an alarm device 32. The image capturing device 31 comprises a digital signal processor 33, which contains a motion determining unit 331, a color model analyzing unit 332, a flickering frequency analyzing unit 333, a comparing unit 334 and a database 335. The database 335 stores abundant flame features obtained from experiments including the Gaussian color model and the flickering frequency data.

The flame detecting device captures a video segment containing several objects through the image capturing device 31. Whether the objects are moving are determined by using the updating background motion determining method of the motion determining unit 331. The colors of the moving objects are analyzed by the color model analyzing unit 332. The flickering frequency relates to the color variation of the moving objects with time which is analyzed by using the time wavelet calculating method of the flickering frequency analyzing unit 333. Then, the comparing unit 334 compares the analyzed data to the flame features data in the database 335 to determine if the objects have the same color model and flickering frequency as the flame. If the above features of the objects match the flame features, the flame detecting device determines the objects as flames and generates an alarm signal through the alarm device 32. The alarm device 32 sends the alarm signal to the central controlling computer of the fire monitoring center, the flame signal receiver or a cellphone.

The database 18, 245, 335 in the flame detecting device of the present invention stores lots of the flame features data which are the flame image analyzed data from a lot of fire documentary films. In these flame features data, the color model is the flame image data analyzed by the Gaussian mixture model (GMM), which is a three-dimensional analysis model and used for analyzing the flame color pixels varying degree with time and space. The flickering frequency is obtained from a one-dimensional analysis which analyzes the flame color varying degree with time. Subsequently, the analyzed data are calculated as the statistical data and stored in the database for comparison. Besides, the database 18, 245, 335 further has the learning and the updating abilities so that once the flame detecting device detects a real flame, the database 18, 245, 335 will add the detected data thereinto and update the color model and the flickering frequency data, so as to make the subsequent analysis more precise.

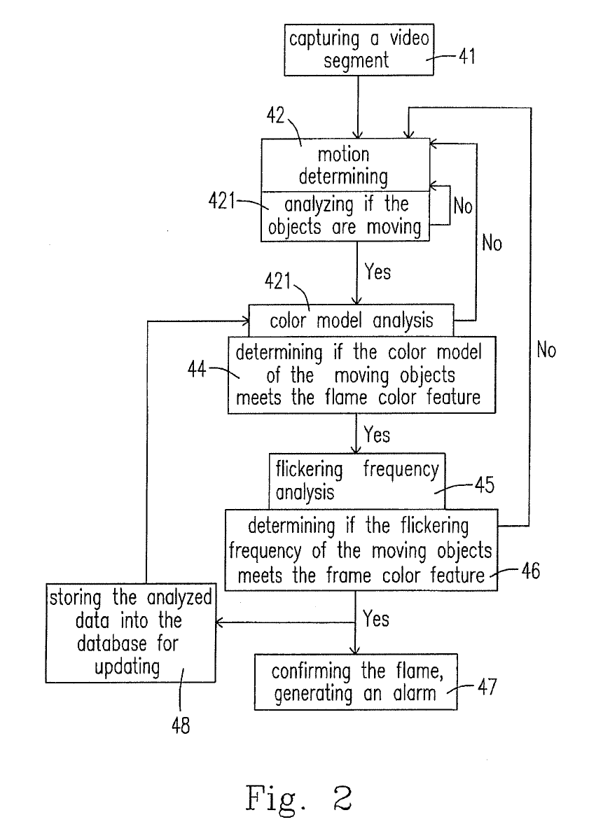

Please refer to FIG. 2, which is the flow chart of the flame detecting method in the present invention. Firstly, a video segment is captured (step 41). Then, the motion determining is performed (step 42) to analyze if the objects in the video segment are moving (step 421). If yes, the flow proceeds to step 43; if not, the flow goes back to step 42. Next, the color model analysis is performed (step 43) to analyze the color model of the moving object and determine if it meets the flame color feature (step 44). If yes, the flow proceeds to step 45; if not, the flow goes back to step 42. Subsequently, the flickering frequency analysis is performed (step 45) to analyze the flickering frequency of the moving object and determine if it meets the flame color feature 46. If yes, the flow proceeds to steps 47 and 48; if not, the flow goes back to step 42. Step 47 is to confirm the flame and generate an alarm signal. Step 48 is to store the above analyzed data into the database for updating.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A flame detecting method, comprising steps of:
capturing a video segment for a object;
analyzing if an image of the object is moving;
analyzing at least one of a color model and a flickering frequency of the moving object;
comparing analyzed results obtained from the analyzing steps to a flame feature; and
determining if the moving object is a flame.

2. A flame detecting method as claimed in claim 1, further comprising:
sending out an alarm when the moving object is determined as the flame.

3. A flame detecting device, comprising:
an image capturing device capturing a video segment having an image for a object;
a first analyzing device coupled to the image capturing device and analyzing if the object is moving;
a second analyzing device coupled to the image capturing device and analyzing at least one of a color model and a flickering frequency of the moving object; and
a comparing device coupled to the analyzing devices and comparing analyzed results obtained from the analyzing devices to a flame feature.

4. A flame detecting device according to claim 3 further comprising:
a storage device coupled to the comparing device and storing the flame feature.

5. A flame detecting device according to claim 4, wherein the storage device further stores the analyzed results when the moving object is the flame for updating the flame feature.

6. A flame detecting device according to claim 3 further comprising:
an alarming device coupled to the comparing device for generating an alarm when the moving object is the flame.

7. A flame detecting device according to claim 3, wherein the image capturing device is one of a web camera and a cable camera.

8. A flame detecting device according to claim 3, wherein the color model is a Gaussian mixture model resulting from a statistics for a color of the moving object.

9. A flame detecting device, comprising:
an image capturing device capturing an image of a object; and
a first analyzing device coupled to the image capturing device for analyzing at least one of a flickering frequency and a color model of the image for determining if the substrate is a flame.

10. A flame detecting device according to claim 9 further comprising:
a second analyzing device coupled to the image capturing device and analyzing if the object is moving; and
a comparing device coupled to the analyzing devices and comparing analyzed results obtained from the analyzing devices to the flame feature.

11. A flame detecting device according to claim 10 further comprising:
a storage device coupled to the comparing device and storing the flame feature.

12. A flame detecting device according to claim 11, wherein the storage device further stores the analyzed results when the object is the flame for updating the flame feature.

13. A flame detecting device according to claim 9 further comprising an alarming device coupled to the flame detecting device for generating an alarm when the object is the flame.

14. A flame detecting device according to claim 9, wherein the image capturing device is one of a web camera and a cable camera.

15. A flame detecting device according to claim 9, wherein the flickering frequency is a color variation of the image varying with time.

16. A flame detecting device according to claim 9, wherein the color model is a Gaussian mixture model resulting from a statistics for a color of the object.
